(19) United States
(12) Patent Application Publication
(10) Pub. No.: US 2025/0132823 A1
(43) Pub. Date: Apr. 24, 2025

(54) SATELLITE INTERNET CONSTELLATION CONTENT DELIVERY NETWORK AND DATA CENTER

(71) Applicant: Armada Systems Inc., Greebrae, CA (US)

(72) Inventor: Stuart Alexander Jacobson, San Francisco, CA (US)

(21) Appl. No.: 18/834,530

(22) PCT Filed: Jan. 30, 2023
(86) PCT No.: PCT/US2023/061603

§ 371 Date: Jul. 30, 2024

Related U.S. Application Data
(60) Provisional application No. 63/305,149, filed on Jan. 31, 2022.

(51) Int. Cl. H04B 7/185

(52) U.S. Cl. CPC H04B 7/18558; H04B 7/18517; H04B 7/18521

(57) ABSTRACT

Systems and techniques are provided for wireless communications. For example, a system can include a plurality of satellite dishes provided about a first location and configured for communication with a satellite internet constellation. Each respective satellite dish can be communicatively interconnected with one or more satellite dishes of the plurality of satellite dishes. The system can include a user equipment (UE) communicatively coupled to an adjacent satellite dish of the plurality of satellite dishes. Data traffic of the UE can be routed from the adjacent satellite dish to a selected satellite dish of the plurality of satellite dishes. The data traffic of the UE can be transmitted to the satellite internet constellation using the selected satellite dish. The data traffic of the UE can be routed to an internet gateway using one or more inter-satellite links (ISLs) between respective pairs of satellites of the satellite internet constellation.

### CROSS-REFERENCE TO RELATED APPLICATIONS

This application claims the benefit of priority to U.S. Provisional Patent Application No. 63/305,149 filed Jan. 31, 2022 and entitled “SATELLITE INTERNET CONSTELLATION CONTENT DELIVERY NETWORK AND DATA CENTER,” the disclosure of which is herein incorporated by reference in its entirety.

### TECHNICAL FIELD

The present disclosure pertains to wireless communications, and more specifically pertains to improved content delivery using a satellite constellation data network.

### BACKGROUND

Low-orbit satellite constellation systems have been rapidly developed and deployed to provide wireless communications and data network connectivity. For instance, low-orbit satellite constellation systems (collectively referred to herein as “satellite constellations”) can include a plurality of discrete satellites arranged in a low-earth orbit (LEO), for example within the range of 500 km-1500 km. At an altitude of approximately 500 km above the surface of the Earth, the round trip latency between an LEO satellite and a terrestrial transceiver (e.g., transmitter and/or receiver) is often on the order of 20 milliseconds. By comparison, existing geosynchronous satellites orbit the Earth at 35,786 km and may have a round trip latency of 600 milliseconds or more.

The fleet of discrete satellites (also referred to as “birds”) included in a satellite constellation can be arranged as a global satellite constellation that provides at least periodic or intermittent coverage to a large portion of the Earth's surface. In many cases, at least certain areas of the Earth's service may have continuous or near-continuous coverage from at least one bird of the satellite constellation. For instance, a global satellite constellation can be formed based on a stable (and therefore predictable) space geometric configuration, in which the fleet of birds maintain fixed space-time relationships with one another. A satellite constellation be used to provide data network connectivity to ground-based devices and/or other terrestrial receivers. For example, a satellite constellation can be integrated with or otherwise provide connectivity to one or more terrestrial (e.g., on-ground) data networks, such as the internet, a 4G/LTE network, and/or a 5G/NR network, among various others.

### BRIEF SUMMARY

In some examples, systems and techniques are described for wireless communications using a satellite internet constellation. According to at least one illustrative example, a system for wireless communications is provided, the system comprising: a plurality of satellite dishes provided about a first location and configured for communication with a satellite internet constellation, wherein each respective satellite dish is communicatively interconnected with one or more satellite dishes of the plurality of satellite dishes; and a user equipment (UE) communicatively coupled to an adjacent satellite dish of the plurality of satellite dishes, wherein: data traffic of the UE is routed from the adjacent satellite dish to a selected satellite dish of the plurality of satellite dishes; the data traffic of the UE is transmitted to the satellite internet constellation using the selected satellite dish; and the data traffic of the UE is routed to an internet gateway using one or more inter-satellite links (ISLs) between respective pairs of satellites of the satellite internet constellation.

In another illustrative example, a method for wireless communications is provided, the method comprising: routing data traffic of a user equipment (UE) from an adjacent satellite dish of a plurality of satellite dishes to a selected satellite dish of a plurality of satellite dishes, wherein: the UE is communicatively coupled to the adjacent satellite dish of the plurality of satellite dishes; and the plurality of satellite dishes is provided about a first location and configured for communication with a satellite internet constellation, wherein each respective satellite dish is communicatively interconnected with one or more satellite dishes of the plurality of satellite dishes; transmitting the data traffic of the UE to the satellite internet constellation using the selected satellite dish; and routing the data traffic of the UE to an internet gateway using one or more inter-satellite links (ISLs) between respective pairs of satellites of the satellite internet constellation.

In another illustrative example, a non-transitory computer-readable storage medium is provided, comprising instructions stored thereon, the instructions configured to cause one or more processor to perform operations comprising: routing data traffic of a user equipment (UE) from an adjacent satellite dish of a plurality of satellite dishes to a selected satellite dish of a plurality of satellite dishes, wherein: the UE is communicatively coupled to the adjacent satellite dish of the plurality of satellite dishes; and the plurality of satellite dishes is provided about a first location and configured for communication with a satellite internet constellation, wherein each respective satellite dish is communicatively interconnected with one or more satellite dishes of the plurality of satellite dishes; transmitting the data traffic of the UE to the satellite internet constellation using the selected satellite dish; and routing the data traffic of the UE to an internet gateway using one or more inter-satellite links (ISLs) between respective pairs of satellites of the satellite internet constellation.

In another illustrative example, an apparatus for wireless communications is provided, the apparatus comprising: means for routing data traffic of a user equipment (UE) from an adjacent satellite dish of a plurality of satellite dishes to a selected satellite dish of a plurality of satellite dishes, wherein: the UE is communicatively coupled to the adjacent satellite dish of the plurality of satellite dishes; and the plurality of satellite dishes is provided about a first location and configured for communication with a satellite internet constellation, wherein each respective satellite dish is communicatively interconnected with one or more satellite dishes of the plurality of satellite dishes; means for transmitting the data traffic of the UE to the satellite internet constellation using the selected satellite dish; and means for routing the data traffic of the UE to an internet gateway using one or more inter-satellite links (ISLs) between respective pairs of satellites of the satellite internet constellation.

In some aspects, the adjacent satellite dish transmits the data traffic of the UE to the selected satellite dish using one or more hops between intermediate satellite dishes of the plurality of satellite dishes.

In some aspects, the intermediate satellite dishes are selected from a group of interconnected satellite dishes provided between the adjacent satellite dish and the selected satellite dish.

In some aspects, a location of the adjacent satellite dish is different from a location of the selected satellite dish; and a subset of satellites of the satellite internet constellation available to the adjacent satellite dish is different from a subset of satellites of the satellite internet constellation available to the selected satellite dish.

In some aspects, the selected satellite dish transmits the data traffic of the UE to a particular satellite of the satellite internet constellation, and wherein the particular satellite is beyond a communication range of the adjacent satellite dish.

In some aspects, the plurality of satellite dishes are arranged in two or more concentric layers disposed beyond a perimeter of the first location, each layer including a subset of the plurality of satellite dishes.

In some aspects, the adjacent satellite dish is included in an inner layer of the two or more concentric layers; and the selected satellite dish is included in a layer different from the inner layer.

In some aspects, the two or more concentric layers include at least an inner layer and an outer layer; and at least one satellite dish included in the inner layer is communicatively coupled to at least one satellite dish included in the outer layer.

In some aspects, the selected satellite dish is selected based on a latency or round trip time (RTT) associated with an available path between the selected satellite dish and the internet gateway.

In some aspects, the selected satellite dish is selected based on having a lowest latency to the internet gateway.

In some aspects, the internet gateway is selected from a plurality of internet gateways associated with the satellite internet constellation, based on the internet gateway having a lowest latency or closest proximity to a content server associated with the data traffic of the UE.

In some aspects, the internet gateway comprises a server-side proxy or a datacenter of a Content Delivery Network (CDN).

In some aspects, the selected satellite dish is selected based on identifying a routing path from the selected satellite dish to a satellite of the satellite internet constellation having a lowest latency or round trip time (RTT) to the server-side proxy or datacenter of the CDN.

In some aspects, the data traffic of the UE is transmitted by the selected satellite dish to an ingress satellite of the satellite internet constellation; and the data traffic of the UE is transmitted from an egress satellite of the satellite internet constellation to the internet gateway.

In some aspects, the one or more ISL links are provided between the ingress satellite and the egress satellite.

In some aspects, the selected satellite dish is selected based at least in part on a communication link being available between the selected satellite dish and the ingress satellite, and wherein a communication link between the adjacent satellite dish and the ingress satellite is unavailable.

In some aspects, a second plurality of satellite dishes is provided about a second location and configured for communication with the satellite internet constellation, wherein each respective satellite dish is communicatively interconnected with one or more satellite dishes of the second plurality of satellite dishes.

In some aspects, the second location is a location of a server-side proxy or a datacenter of a Content Delivery Network (CDN); and data traffic addressed to the UE is routed through the second plurality of satellite dishes to a second selected satellite dish configured to transmit, to the satellite internet constellation, the data traffic addressed to the UE.

In some aspects, the data traffic addressed to the UE is further routed from an ingress satellite of the satellite internet constellation to an egress satellite of the satellite internet constellation, using one more ISLs between a corresponding one or more pairs of satellites of the satellite internet constellation.

In some aspects, the egress satellite transmits the data traffic addressed to the UE to the selected satellite dish of the plurality of satellite dishes; and the data traffic addressed to the UE is forwarded from the selected satellite dish to the UE via one or more intermediate satellite dishes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. The use of a same reference numbers in different drawings indicates similar or identical items or features. Understanding that these drawings depict only exemplary embodiments of the disclosure and are not therefore to be considered to be limiting of its scope, the principles herein are described and explained with additional specificity and detail through the use of the accompanying drawings in which:

FIG. 1 depicts an example design of a base station and a user equipment (UE) for transmission and processing of signals exchanged between the UE and the base station, in accordance with some examples;

FIG. 2 is a diagram illustrating an example configuration of a Non-Terrestrial Network (NTN) for providing data network connectivity to terrestrial (ground-based) devices, in accordance with some examples;

FIG. 3 is a diagram illustrating an example of a satellite internet constellation content delivery network (CDN) that can be used to provide low latency satellite internet connectivity, in accordance with some examples;

FIG. 4A is a diagram illustrating an example configuration of polygon layers of satellite dishes that may be utilized at client-side location(s) and/or server-side location(s) associated with a satellite internet constellation, in accordance with some examples;

FIG. 4B is a diagram illustrating another example configuration of polygon layers of satellite dishes that may be utilized at client-side location(s) and/or server-side location(s) associated with a satellite internet constellation, in accordance with some examples; and

FIG. 5 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

The term “network entity” or “base station” may refer to a single physical Transmission-Reception Point (TRP) or to multiple physical Transmission-Reception Points (TRPs) that may or may not be co-located. For example, where the term “network entity” or “base station” refers to a single physical TRP, the physical TRP may be an antenna of a base station (e.g., satellite constellation ground station/internet gateway) corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Because a TRP is the point from which a base station transmits and receives wireless signals, as used herein, references to transmission from or reception at a base station are to be understood as referring to a particular TRP of the base station.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Further details regarding the systems and techniques described herein will be discussed below with respect to the figures.

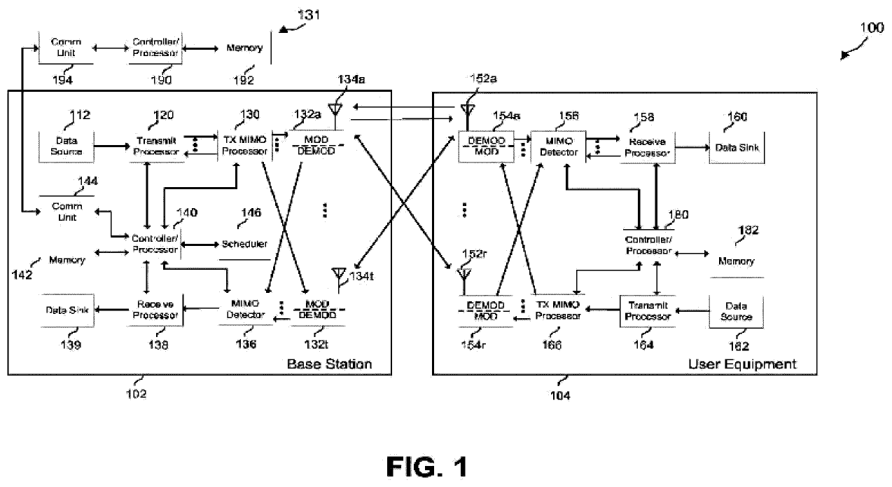

FIG. 1 shows a block diagram of a design of a base station 102 and a UE 104 that enable transmission and processing of signals exchanged between the UE and the base station, in accordance with some aspects of the present disclosure. Design 100 includes components of a base station 102 and a UE 104. In some examples, the architecture of base station 102 can be the same as or similar to an architecture used to implement a satellite constellation ground station (e.g., internet gateway for providing internet connectivity via a satellite constellation). In some examples, the architecture of base station 102 can be the same as or similar to an architecture used to implement a satellite of a satellite constellation.

As illustrated, base station 102 may be equipped with T antennas 134a through 134t, and UE 104 may be equipped with R antennas 152a through 152r, where in general T≥1 and R≥1. At base station 102, a transmit processor 120 may receive data from a data source 112 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 120 may also process system information (e.g., for semi-static resource partitioning information (SRPI) and/or the like) and control information (e.g., CQI requests, grants, upper layer signaling, and/or the like) and provide overhead symbols and control symbols. Transmit processor 120 may also generate reference symbols for reference signals (e.g., the cell-specific reference signal (CRS)) and synchronization signals (e.g., the primary synchronization signal (PSS) and secondary synchronization signal (SSS))). A transmit (TX) multiple-input multiple-output (MIMO) processor 130 may perform spatial processing (e.g., precoding) on the data symbols, the control symbols, the overhead symbols, and/or the reference symbols, if applicable, and may provide T output symbol streams to T modulators (MODs) 132a through 132t. The modulators 132a through 132t are shown as a combined modulator-demodulator (MOD-DEMOD). In some cases, the modulators and demodulators can be separate components. Each modulator of the modulators 132a to 132t may process a respective output symbol stream, e.g., for an orthogonal frequency-division multiplexing (OFDM) scheme and/or the like, to obtain an output sample stream. Each modulator of the modulators 132a to 132t may further process (e.g., convert to analog, amplify, filter, and upconvert) the output sample stream to obtain a downlink signal. T downlink signals may be transmitted from modulators 132a to 132t via T antennas 134a through 134t, respectively. According to certain aspects described in more detail below, the synchronization signals can be generated with location encoding to convey additional information.

At UE 104, antennas 152a through 152r may receive the downlink signals from base station 102 and/or other base stations and may provide received signals to demodulators (DEMODs) 154a through 154r, respectively. The demodulators 154a through 154r are shown as a combined modulator-demodulator (MOD-DEMOD). In some cases, the modulators and demodulators can be separate components. Each demodulator of the demodulators 154a through 154r may condition (e.g., filter, amplify, downconvert, and digitize) a received signal to obtain input samples. Each demodulator of the demodulators 154a through 154r may further process the input samples (e.g., for OFDM and/or the like) to obtain received symbols. A MIMO detector 156 may obtain received symbols from all R demodulators 154a through 154r, perform MIMO detection on the received symbols if applicable, and provide detected symbols. A receive processor 158 may process (e.g., demodulate and decode) the detected symbols, provide decoded data for UE 104 to a data sink 160, and provide decoded control information and system information to a controller/processor 180. A channel processor may determine reference signal received power (RSRP), received signal strength indicator (RSSI), reference signal received quality (RSRQ), channel quality indicator (CQI), and/or the like.

On the uplink, at UE 104, a transmit processor 164 may receive and process data from a data source 162 and control information (e.g., for reports comprising RSRP, RSSI, RSRQ, CQI, and/or the like) from controller/processor 180. Transmit processor 164 may also generate reference symbols for one or more reference signals (e.g., based at least in part on a beta value or a set of beta values associated with the one or more reference signals). The symbols from transmit processor 164 may be precoded by a TX-MIMO processor 166 if application, further processed by modulators 154a through 154r (e.g., for DFT-s-OFDM, CP-OFDM, and/or the like), and transmitted to base station 102. At base station 102, the uplink signals from UE 104 and other UEs may be received by antennas 134a through 134t, processed by demodulators 132a through 132t, detected by a MIMO detector 136 if applicable, and further processed by a receive processor 138 to obtain decoded data and control information sent by UE 104. Receive processor 138 may provide the decoded data to a data sink 139 and the decoded control information to controller (e.g., processor) 140. Base station 102 may include communication unit 144 and communicate to a network controller 131 via communication unit 144. Network controller 131 may include communication unit 194, controller/processor 190, and memory 192. In some aspects, one or more components of UE 104 may be included in a housing. Memories 142 and 182 may store data and program codes for the base station 102 and the UE 104, respectively. A scheduler 146 may schedule UEs for data transmission on the downlink, uplink, and/or sidelink.

### Data Network Connectivity Using Satellite Constellations

As noted previously, low-orbit satellite constellation systems have been rapidly developed and deployed to provide wireless communications and data network connectivity. A fleet of discrete satellites (also referred to as “birds”) can be arranged as a global satellite constellation that provides at least periodic or intermittent coverage to a large portion of the Earth's surface. In many cases, at least certain areas of the Earth's service may have continuous or near-continuous coverage from at least one bird of the satellite constellation. For instance, a global satellite constellation can be formed based on a stable (and therefore predictable) space geometric configuration, in which the fleet of birds maintain fixed space-time relationships with one another. A satellite constellation be used to provide data network connectivity to ground-based devices and/or other terrestrial receivers. For example, a satellite constellation can be integrated with or otherwise provide connectivity to one or more terrestrial (e.g., on-ground) data networks, such as the internet, a 4G/LTE network, and/or a 5G/NR network, among various others. In one illustrative example, a satellite internet constellation system can include a plurality of discrete satellites arranged in a low-earth orbit and used to provide data network connectivity to the internet.

To implement an internet satellite constellation, the discrete satellites can be used as space-based communication nodes that couple terrestrial devices to terrestrial internet gateways. The terrestrial internet gateways may also be referred to as ground stations, and are used to provide connectivity to the internet backbone. For instance, a given satellite can provide a first communication link to a terrestrial device and a second communication link to a ground station that is connected to an internet service provider (ISP). The terrestrial device can transmit data and/or data requests to the satellite over the first communication link, with the satellite subsequently forwarding the transmission to the ground station internet gateway (from which point onward the transmission from the device is handled as a normal internet transmission). The terrestrial device can receive data and/or requests using the reverse process, in which the satellite receives a transmission from the ground station internet gateway via the second communication link and then forwards the transmission to the terrestrial device using the first communication link.

Although an internet satellite constellation includes a fleet of discrete satellites, it is often the case that terrestrial devices communicating with a satellite can only be connected to a ground station/internet gateway that is also able to communicate with the same satellite. In other words, it is typically the case that the first and second communication links described above must be established with the same satellite of the satellite constellation. A user connecting to any particular satellite is therefore limited by the ground station/internet gateways that are visible to that particular satellite. For instance, a user connected to a satellite that is unable to establish a communication link with a ground station/internet gateway is therefore unable to connect to the internet-although the fleet of satellites is a global network in terms of spatial diversity and arrangement, the individual satellites function as standalone internet relay nodes unless an inter-satellite link capability is provided.

In some cases, inter-satellite links can allow point to point communications between the individual satellites included in a satellite constellation. For instance, data can travel at the speed of light from one satellite to another, resulting in a fully interconnected global mesh network that allows access to the internet as long as the terrestrial device can establish communication with at least one satellite of the satellite internet constellation. In one illustrative example, a satellite internet constellation can implement inter-satellite links as optical communication links. For example, optical space lasers can be used to implement optical intersatellite links (ISLs) between some (or all) of the individual birds of a satellite constellation. In this manner, the satellite internet constellation can be used to transmit data without the use of local ground stations, and may be seen to provide truly global coverage.

For instance, optical laser links between individual satellites in a satellite constellation can reduce long-distance latency by as much as 50%. Additionally, optical laser links (e.g., ISLs) can enable the more efficient sharing of capacity by utilizing the otherwise wasted satellite capacity over regions without ground station internet gateways. Moreover, optical laser links allow the satellite constellation to provide internet service (or other data network connectivity) to areas where ground stations are not present and/or are impossible to install.

To implement a satellite constellation, one or more satellites may be integrated with the terrestrial infrastructure of a wireless communication system. In general, satellites may refer to Low Earth Orbit (LEO) devices, Medium Earth Orbit (MEO) devices, Geostationary Earth Orbit (GEO) devices, and/or Highly Elliptical Orbit (HEO) devices. In some aspects, a satellite constellation can be included in or used to implement a non-terrestrial network (NTN). A non-terrestrial network (NTN) may refer to a network, or a segment of a network, that uses an airborne or spaceborne vehicle for transmission. For instance, spaceborne vehicles can refer to various ones of the satellites described above. An airborne vehicle may refer to High Altitude Platforms (HAPs) including Unmanned Aircraft Systems (UAS). An NTN may be configured to help to provide wireless communication in un-served or underserved areas to upgrade the performance of terrestrial networks. For example, a communication satellite (e.g., of a satellite constellation) may provide coverage to a larger geographic region than a terrestrial network base station. The NTN may also reinforce service reliability by providing service continuity for UEs or for moving platforms (e.g., passenger vehicles-aircraft, ships, high speed trains, buses). The NTN may also increase service availability, including critical communications. The NTN may also enable network scalability through the provision of efficient multicast/broadcast resources for data delivery towards the network edges or even directly to the user equipment.

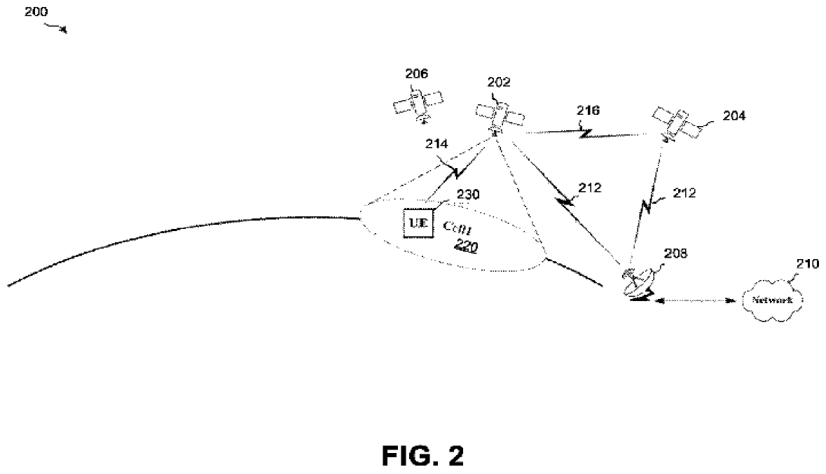

FIG. 2 is a diagram illustrating an example configuration 200 of an NTN for providing data network connectivity to terrestrial (ground-based) devices. In one illustrative example, the NTN can be a satellite internet constellation, although various other NTNs and/or satellite constellation data network connectivity types may also be utilized without departing from the scope of the present disclosure. As used herein, the terms “NTN” and “satellite constellation” may be used interchangeably.

An NTN may refer to a network, or a segment of a network, that uses RF resources on-board an NTN platform. The NTN platform may refer to a spaceborne vehicle or an airborne vehicle. Spaceborne vehicles include communication satellites that may be classified based on their orbits. For example, a communication satellite may include a GEO device that appears stationary with respect to the Earth. As such, a single GEO device may provide coverage to a geographic coverage area. In other examples, a communication satellite may include a non-GEO device, such as an LEO device, an MEO device, or an HEO device. Non-GEO devices do not appear stationary with respect to the Earth. As such, a satellite constellation (e.g., one or more satellites) may be configured to provide coverage to the geographic coverage area. An airborne vehicle may refer to a system encompassing Tethered UAS (TUA), Lighter Than Air UAS (LTA), Heavier Than Air UAS (HTA) (e.g., in altitudes typically between 8 and 50 km including High Altitude Platforms (HAPs)).

A satellite constellation can include a plurality of satellites, such as the satellites 202, 204, and 206 depicted in FIG. 2. The plurality of satellites can include satellites that are the same as one another and/or can include satellites that are different from one another. A terrestrial gateway 208 can be used to provide data connectivity to a data network 210. For instance, the terrestrial gateway 208 can be a ground station (e.g., internet gateway) for providing data connectivity to the internet. Also depicted in FIG. 2 is a UE 230 located on the surface of the earth, within a cell coverage area of the first satellite 202. In some aspects, the UE 230 can include various devices capable of connecting to the NTN 200 and/or the satellite constellation thereof for wireless communication.

The gateway 208 may be included in one or more terrestrial gateways that are used to connect the NTN 200 and/or satellite constellation thereof to a public data network such as the internet. In some examples, the gateway 208 may support functions to forward a signal from the satellite constellation to a Uu interface, such as an NR-Uu interface. In other examples, the gateway 208 may provide a transport network layer node, and may support various transport protocols, such as those associated with providing an IP router functionality. A satellite radio interface (SRI) may provide IP trunk connections between the gateway 208 and various satellites (e.g., satellites 202-206) to transport NG or F1 interfaces, respectively.

Satellites within the satellite constellation that are within connection range of the gateway 208 (e.g., within line-of-sight of, etc.) may be fed by the gateway 208. The individual satellites of the satellite constellation can be deployed across a satellite-targeted coverage area, which can correspond to regional, continental, or even global coverage. The satellites of the satellite constellation may be served successively by one or more gateways at a time. The NTN 200 associated with the satellite constellation can be configured to provide service and feeder link continuity between the successive serving gateways 208 with time duration to perform mobility anchoring and handover.

In one illustrative example, the first satellite 202 may communicate with the data network 210 (e.g., the internet) through a feeder link 212 established between the first satellite 202 and the gateway 208. The feeder link 212 can be used to provide bidirectional communications between the first satellite 202 and the internet backbone coupled to or otherwise provided by gateway 208. The first satellite 202 can communicate with the UE 230 using a service link 214 established within the cell coverage (e.g., field-of-view) area of an NTN cell 220. The NTN cell 220 corresponds to the first satellite 202. In particular, the first satellite 202 and/or service link 214 can be used to communicate with various different devices or UEs that are located within the corresponding NTN cell 220 of first satellite 202.

More generally, a feeder link (such as feeder link 212) may refer to a wireless link between a gateway and a particular satellite of a satellite constellation. A service link (such as service link 214) may refer to a wireless link between a UE and particular satellite of a satellite constellation. In some examples, one or more (or all) of the satellites of a satellite constellation can use one or more directional beams (e.g., beamforming) to communicate with the UE 230 via service link 214 and/or to communicate with the ground station/internet gateway 208 via feeder link 212. For instance, the first satellite 202 may use directional beams (beamforming) to communicate with UE 230 via service link 214 and/or to communicate with gateway 208 via feeder link 212. A beam may refer to a wireless communication beam generated by an antenna on-board a satellite.

In some examples, the UE 230 may communicate with the first satellite 202 via the service link 214, as described above. Rather than the first satellite 202 then using the feeder link 212 to forward the UE communications to internet gateway 208, the first satellite 202 may instead relay the communication to second satellite 204 through an inter-satellite link (ISL) 216. The second satellite 204 can subsequently communicate with the data network 210 (e.g., internet) through a feeder link 212 established between the second satellite 204 and the internet gateway 208. In some aspects, the ISL links can be provided between a constellation of satellites and may involve the use of transparent payloads on-board the satellites. The ISL link may operate in an RF frequency or an optical band. In one illustrative example, the ISL links between satellites of a satellite constellation can be implemented as optical laser links (e.g., using optical space laser transceivers provided on the satellites), as was noted previously above.

In the illustrated example of FIG. 2, the first satellite 202 may provide the NTN cell 220 with a first physical cell ID (PCI). In some examples, a constellation of satellites may provide coverage to the NTN cell 220. For example, the first satellite 202 may include a non-GEO device that does not appear stationary with respect to the Earth. For instance, the first satellite 202 can be a low-earth orbit (LEO) satellite included in a LEO satellite constellation for providing data network connectivity. As such, a satellite constellation (e.g., one or more satellites) may be configured to provide coverage to the NTN cell 220. For example, the first satellite 202, second satellite 204, and third satellite 206 may be part of a satellite constellation that provides coverage to the NTN cell 220.

In some examples, satellite constellation deployment may provide different services based on the type of payload onboard the satellite(s). The type of payload may determine whether the satellite acts as a relay node or a base station. For example, a transparent payload is associated with the satellite acting as a relay node, while a non-transparent payload is associated with the satellite acting as a base station. A transparent payload may implement frequency conversion and a radio frequency (RF) amplifier in both uplink (UL) and downlink (DL) directions and may correspond to an analog RF repeater. A transparent payload, for example, may receive UL signals from all served UEs and may redirect the combined signals DL to an earth station (e.g., internet gateway 208) without demodulating or decoding the signals. Similarly, a transparent payload may receive an UL signal from an earth station and redirect the signal DL to served UEs without demodulating or decoding the signal. However, the transparent payload may frequency convert received signals and may amplify and/or filter received signals before transmitting the signals.

A non-transparent payload may receive UL signals and demodulate or decode the UL signal before generating a DL signal. For instance, the first satellite 202 may receive UL signals from one or more served UEs (e.g., within the cell 220) and subsequently demodulate or decode the UL signals prior to generating one or more corresponding DL signals to the internet gateway 208. Similarly, the first satellite 202 may receive UL signals from the internet gateway 208 and subsequently demodulate or decode the UL signals prior to generating one or more corresponding DL signals to the served UEs within cell 220.

### Satellite Internet Constellations

A satellite internet constellation is a fleet of satellite internet constellation satellites (also referred to as “birds”) arranged in a low-earth orbit (LEO). Satellite internet constellations can be implemented based on the idea that, with a sufficiently large constellation, at any given time at least one satellite should be sufficiently close to communicate with both a user satellite dish and a satellite dish at an internet gateway. In such implementations, the internet gateway satellite dish is typically located in the same general vicinity (e.g., geographic area) as the user satellite dish because, as noted previously above, the same satellite is used to communicate with both the internet gateway and the user. Based on the same satellite communicating with both the user and the internet gateway, the satellite can be used to route (e.g., relay) internet traffic between the customer and the internet via the internet gateway.

Advantageously, users of such satellite internet constellations can connect to the internet without the requirement of having a physical connection to the internet gateway. For instance, internet users are typically connected to an internet gateway via a series of intermediate connections (also referred to as hops). In many cases, the direct physical connections between internet users and internet gateways are provided via internet service providers (ISPs), for example over fiber optic cables or copper lines. Satellite internet constellations (and the associated satellite internet service thereof) can be valuable for users for whom direct physical connections to an internet gateway are unavailable or otherwise prohibitively expensive. For instance, users in rural or low density areas may not have access to the internet and/or may not have access to high-speed (e.g., fiber) internet because the cost of a ground-based physical connection to a gateway cannot be amortized over a sufficiently large quantity of users to justify the expense (e.g., as physical internet infrastructure is often built out by ISPs with the expectation of recouping the buildout cost via monthly internet service fees charged to its customers).

Satellite internet constellations can provide internet access to both users who are adequately served by conventional/existing physical ground-based internet connections and to users who are not adequately served (if served at all) by the existing physical ground-based internet connections. In some cases, geographic considerations beyond population density can also be an impediment to providing ground-based internet connectivity. For instance, countries such as Indonesia are densely populated but have a landmass that is spread across numerous islands-in this case, it is logistically challenging and financially cumbersome to run fiber connections to all of the islands. Accordingly, geographic considerations can also act as a barrier to internet access when using conventional ground-based physical connections between users and internet gateways.

However, satellite internet constellations are not subject to the same geographic constraints as ground-based internet connections and, moreover, can often be financially justified based on the ability to amortize the higher capital costs across a significantly larger number of users (e.g., given that satellite internet constellations can provide multi-national or global coverage, based on the individual satellites completing multiple earth orbits per day). In the example of countries such as Indonesia, the separate islands are sufficiently proximate to one another so as to share a relatively small quantity of common satellite internet constellation internet gateways-in which case fiber connections would only need to be built and maintained to connect the gateways to the internet/internet backbone, as satellite links would be able to connect individual users on various islands to at least one of the gateways.

However, many existing satellite internet constellation approaches may be unable (or unsuitable) to provide satellite internet connectivity to users who are highly isolated from nearby terrestrial internet gateways (e.g., such as passengers onboard airplanes or boats in the open ocean). In this case, such users may have connectivity to one or more birds of the constellation, but there are no nearby terrestrial internet gateways to which the birds may route an internet connection for these users (e.g., the likelihood of an island with sufficient internet connectivity being sufficiently nearby so as to see the same satellite internet constellation bird as the plane/boat passengers is typically very low).

In addition to issues of connectivity that arise from the conventional requirement that the same bird of a satellite internet constellation be in sight of a user and a terrestrial internet gateway in order to provide internet connectivity to the user, existing satellite internet constellation approaches can also suffer from issues of latency.

### Internet Data Connectivity and Latency

The core protocol of the world wide web is the Hypertext Transfer Protocol (HTTP). In particular, HTTP is an application layer protocol in the internet protocol model. HTTP functionality is typically based on an HTTP client (usually a web browser, also referred to as a web client) opening a secure TCP/IP connection to an HTTP server (e.g., a web server) and sending an HTTP request for a particular webpage, usually of the form “GET/some/page.html” with various other metadata in the form of MIME headers (Multipurpose Internet Mail Extensions). The web server receives the HTTP request, performs computation(s) associated with the request, and replies to the client with a status code (usually of the form “200 OK” followed by MIME headers followed by the body of the HTTP response).

If the response is HTML (Hypertext Markup Language), then the HTML response will include references to other content that is needed to render the page requested by the client, for instance other HTML, javascript, images, videos, etc. These references take the form of unique URLs (Uniform Resource Locators, more commonly referred to as links) associated with each piece of content. The content needed to render the requested page can be hosted on the same web server as the requested page itself and/or can be hosted on one or more external servers. If the response from the web server includes URLs that refer to content hosted on the same web server, then the client can use the existing connection to request this additional content. For URLs that refer to content hosted on different/external servers, then the web client will subsequently open connections to each of these sources and make HTTP requests to them as well.

The minimum time required to render a web page is the time required for all of the aforementioned round trips between the web client and the various web servers to be completed. For instance, assuming that all of the content needed to render a web page is hosted on the same web server, then the minimum time required to render the web page is based on performing:
1x TCP/IP round trip to establish the connection between the web client and the web server (e.g., TCP handshake using SYN, SYN/ACK messages)
2x TLS (Transport Layer Security) round trips to secure the connection by exchanging cryptographic key/certificate information between the client and the server
1x HTTP round trip to get the web page (e.g., HTML)
1x HTTP round trip to get the content (e.g., images, video, etc.) on the web page

As such, a 5x core round trip time between the web client and the web server represents the best case scenario of the minimum time required to render a web page, assuming that all of the packets are delivered and assuming that the HTML and the content are both only one packet large. The minimum time required to render a web page can quickly grow as the above assumptions are loosened, and brought closer into line with reality. For instance, if the HTML and the content are both larger than one packet, then the minimum web page rendering time grows by the additional amount of time required to send the HTML and the content with respect to the bandwidth of the connection. Accounting for the risk/probability that packets will be dropped while they are sent adds additional time as well, as dropped packets require additional TCP round trips between the client and the server to retrieve (resend) the dropped packets. In reality, at least one additional round trip is added between the client and a domain name server (DNS), which is needed to resolve alphanumeric domain names (e.g., URLs) to corresponding IP addresses.

All round trip times (RTTs) are not equal, as any given RTT may be highly dependent on the network topography underlying the connection. Latency is the time it takes for data packets to pass from one point on a network to another, and each the RTT between a client and a server is equal to double the amount of latency. In particular, the number of different routers that packets must traverse between source and endpoint can vary based on a variety of different factors. Each router traversed by a packet is referred to as a “hop.” In relatively low-traffic conditions, the time between individual hops may generally be on the order of 10s of milliseconds. However, each RTT associated with the minimum web page rendering time can quickly grow as the time between each hop increases (such as in higher-traffic conditions) and as the total number of hops per RTT increases.

Various approaches can be used to reduce internet latency. For example, one approach to reducing latency is based on using client-side caching web proxies, which are often installed by ISPs to lower costs and increase performance. Client-side caching web proxies maintain local copies of frequently accessed content, thereby avoiding at least some RTTs that would otherwise be needed to get the locally stored content from an external web server (e.g., as was described above). For instance, users can configure their browsers to access the internet through these proxy servers when using the ISP. However, one difficulty associated with client-side caching web proxies is properly determining which content to cache-users typically access a sufficiently wide array of content that it becomes difficult or impossible to determine what to cache.

Another approach to reducing latency is based on using CDNs (Content Delivery Networks). CDNs reduce latency by maintaining what are effectively server-side proxies of their customers' websites at network locations that are highly proximate (near) to multiple different ISPs. As such, when various web clients request a particular web page or piece of content that is hosted on the CDN (because the web page/content owner is a customer of the CDN), at least one CDN node should be closer to the web client than the actual server that hosts the web page or content. Accordingly, CDNs can provide an appreciably lower RTT between a web client and a server hosting requested content-and therefore, can provide an appreciably faster web page rendering time. If some of the latency experienced in the absence of a CDN is related to load or bandwidth capacity of the core web server, pushing the service out to a copy hosted on a CDN can reduce that latency as well.

In one illustrative example, customers of a CDN (e.g., web page operators) can use the CDN's domain name servers (DNSs) to return IP addresses for the proxies that the CDN determines or estimates are the closest to the client submitting the DNS request. In a simple CDN implementation, these proxies contain copies of the static content of the web page and must communicate back to the actual web server (e.g., core web server) to retrieve any dynamic content that requires access to real-time server information and/or is personalized for individual end users (e.g., personalized based on user data stored in a database associated with the web page. In the simple CDN implementation, the static content proxies must also communicate back to the core web server in order to send any updates from the web client to the web page's database. Current CDNs have advanced to be able to provide more complex computational and database services, for example based on predictive approaches to determining what content to cache and where the cached content should be stored/made available.

A major cost of existing CDNs, which operate on the principle of reducing internet latency by providing proxy copies of web content nearer to requesting web clients, is in providing sufficient proxy services at a sufficient number of locations so as to be appreciably more performant for the requesting web clients. Accordingly, existing CDN implementations typically require forward deployment of server hardware at a large number of locations. In particular, conventional CDNs forward deploy and scale in relatively expensive data centers that are located in close proximity to requesting web clients (both in terms of physical proximity and network topology proximity, i.e., latency/RTT/number of hops). The costs at each forward deployed CDN location can include the rental of physical space in a local data center; the purchase of hardware sufficient to serve the local users (requesting web clients); installation and maintenance of the hardware; power and cooling to operate the hardware; data costs for low-hop internet connectivity from the CDN to the users; data costs for connections to web servers (e.g., when providing access to small portions of large archives that update regularly); etc. These CDN implementation and operation costs must be amortized over a sufficiently large number of users to justify the buildout of the CDN-accordingly, CDN services can be expensive to customers (e.g., web page operators) and can be challenging for the CDN operator to determine the optimal mix of locations and hardware deployments that are optimal.

Satellite Internet Constellation and Latency

While the use of LEO satellite internet constellations can mitigate the issue of latency as compared to GEO satellite internet (e.g., ˜20 ms RTT vs. ˜700 ms RTT), additional issues of latency may still persist due to issues of network topology outside of the feeder links and service links that a satellite internet constellation bird uses to route internet traffic between UEs and terrestrial internet gateways (e.g., as depicted in FIG. 2).

In particular, satellite internet constellations often utilize internet gateways (such as the terrestrial internet gateway 208 of FIG. 2) that are a relatively large number of hops away from the various websites and/or CDN proxies that users of a satellite internet constellation want to access. As such, satellite internet constellation users can experience latency that arises from the ground-based network topology connecting the terrestrial internet gateways to the rest of the internet.

In some cases, a satellite internet constellation provider may reduce latency by installing client-side proxies (e.g., client-side web caching proxies) in some, or all, of the terrestrial internet gateways utilized by the satellite internet constellation. A satellite internet constellation provider may additionally, or alternatively, utilize one or more CDNs to install server-side proxies, as was described above. However, client-side proxies and server-side proxies (e.g., CDNs) can be expensive to install and maintain, particularly given the relatively low quantity of users per terrestrial gateway-for instance, the number of users per terrestrial gateway may be too low to recoup all of the fixed costs associated with providing a client-side proxy or a server-side proxy.

Accordingly, there is a need for systems and techniques that can be used to more efficiently reduce the latency associated with satellite internet constellations. For instance, there is a need for systems and techniques that can be used to provide terrestrial user connectivity to a satellite internet constellation more efficiently and with lower latency. There is also a need to provide satellite internet constellation connectivity to CDNs and/or other proxies using fewer hops.

Systems, apparatuses, processes (also referred to as methods), and computer-readable media (collectively referred to as “systems and techniques”) are described herein for providing lower latency satellite internet constellation data network connectivity. For instance, latency can be reduced between a client-side and the satellite internet constellation based on providing a plurality of ground-based satellite internet constellation dishes arranged about various geographic locations. In one aspect, one or more rings (e.g., concentric rings) of ground-based satellite dishes can be arranged and interconnected to maximize and/or optimize the utilization of available bandwidth between the satellites of the constellation and ground-based users of the satellite internet constellation.

In another aspect, latency can be reduced between a server-side and the satellite internet constellation based on providing a plurality of ground-based satellite internet constellation dishes arranged about various data center and/or CDN locations. In some cases, the plurality of satellite dishes arranged about data centers or CDNs can be the same as or similar to the plurality of satellite dishes arranged about client-side UEs or users. For instance, same or similar polygonal arrangements of one or more rings (e.g., concentric rings) can be used to provide client-side links to the satellite internet constellation and can be used to provide server-side links to the satellite internet constellation, as will be described in greater depth below.

In another aspect, overall internet latency associated with the satellite internet constellation can be reduced by using the satellite internet constellation to route internet traffic between the client-side users and the server-side data centers/CDNs. For instance, based on a satellite constellation that utilizes optical space lasers or other inter-satellite links (ISLs), low latency satellite internet can be provided without the requirement that the same bird be used to connect a client-side user to a terrestrial internet gateway.

In some embodiments, polygon layers of satellite dishes can be provided at the periphery of relatively high urban density areas (e.g., as the periphery of such areas is lower-density) and may be interconnected to satellite dishes within the high-density areas, thereby increasing the total available satellite internet constellation bandwidth to the area. For example, the polygon layers of satellite dishes can be provided as star-shaped layers, or various other polygonal shapes configured to optimize the use of the satellite internet constellation and/or the available bandwidth thereof. For instance, the polygon layers of satellite dishes described herein can optimize the use (e.g., utilization) of satellite capacity by enabling the connected devices associated with the polygon layers of satellite dishes to reach a greater quantity of birds. In other words, a user or connected device of the satellite internet constellation can reach a greater percentage of the satellite constellation via the polygon layers of satellite dishes than would otherwise be possible via conventional approaches. Moreover, the polygon layers of satellite dishes can be seen to lower the intensity of satellite and/or ground radio signals in the surrounding area proximate to the polygon layers of dishes-for example, polygon layers of satellite dishes can operate with a lower signal intensity (e.g., signal power) as compared to a single dish or lesser quantity of dishes, advantageously permitting the polygon layers of satellite dishes to lessen or minimize interference near data center locations and/or to operate in urban areas with power levels that are below regulator thresholds.

In some embodiments, the ground-based satellite dishes can be interconnected wirelessly (e.g., microwave relay or various other RF communication methods) and/or can be interconnected with physical wired connections (e.g., fiber, etc.). Satellite internet constellation bandwidth may be a function of bandwidth per unit of land area. By increasing the total land area with satellite dishes for communicating with the satellite internet constellation, the total bandwidth to the satellite internet constellation is increased. By interconnecting the plurality of satellite dishes (e.g., interconnecting the dishes within each layer and/or interconnecting the different layers of dishes), this increased quantity of bandwidth can be combined and provided to the high-density urban area, far in excess of the bandwidth that would otherwise be obtainable using non-interconnect satellite dishes installed within the urban area/directly at the point of use.

In another illustrative example, latency can be reduced between the server-side and the satellite internet constellation based on implementing a satellite internet constellation Content Delivery Network (CDN). For instance, a plurality of ground-based satellite internet constellation dishes can be arranged in proximity to servers or data centers that host web pages and content accessed by users of the satellite internet constellation. In some embodiments, the plurality of ground-based satellite dishes can be arranged in proximity to (and communicatively coupled with) existing CDNs, and utilized to provide users of the satellite internet constellation with lower latency (e.g., fewer hops) connections to the CDNs. For instance, as will be described in greater depth below, one or more rings of ground-based satellite dishes can be provided around data origin servers (e.g., web pages, content, APIs, etc.). The data origin servers can be accessed, via the satellite internet constellation, by users having their own satellite internet terminals or ground-based satellite dish. The data origin servers can additionally be accessed by users in areas that are surrounded with one or more rings of ground-based satellite dishes, such as urban areas or other high-density areas. In such embodiments, the operator(s) of the data origin servers can use the satellite internet constellation to more efficiently and effectively provide requested content to users. For instance, rather than having to pay for a local version of the content to be hosted in each urban center (either directly or via a conventional CDN service provider), the data origin servers can communicate directly with the satellite constellation via the ring(s) of satellite dishes arranged around the data origin servers. Notably, it can be more cost effective to provide these rings of satellite dishes local to users/clusters of users and maintain the content of the data origin servers at host locations where it is cheapest to do so, using the satellite internet constellation to then interconnect the two terrestrial locations/connection endpoints.

As such, the systems and techniques described herein can be used to reduce the number of hops between users of a satellite internet constellation and any existing CDN or website data center, based on providing ground-based satellite dishes directly coupled to the existing CDNs and website data centers. In this example, traffic from the birds of the satellite internet constellation can reach the existing CDNs or website data centers in a fewer number of hops (relative to having to traverse the ground-based internet) by being transmitted directly to a ground-based satellite dish that is local to the data origin server.

In some examples, the systems and techniques described herein can additionally, or alternatively, be utilized with distributed CDN and/or data center infrastructure (e.g., as opposed to existing, highly centralized CDN or data center infrastructure). For example, rather than providing concentrated or highly consolidated server-side proxy infrastructure (as is the case with traditional CDNs), the satellite internet constellation CDN described herein can be distributed across a greater number of data center locations. Additionally, the satellite internet constellation CDN can be implemented in a more localized (and/or hyper-localized) fashion, such that server-side content does not need to be forward-deployed at one of only a few, concentrated CDN locations. For instance, the satellite internet constellation CDN described herein can be used in combination with data centers that are located in more remote areas and/or data centers that are distributed across a wider geographic region (both of which can be seen to reduce the cost associated with running the data center). By providing one or more ground-based satellite internet constellation dishes at or near the location of the various data centers (e.g., in the form of one or more rings of satellite dishes around the data origin server locations), the systems and techniques can be used to reach each data origin server more directly as compared to traversing the ground-based internet. Additionally, the systems and techniques can be used to implement a latency-reducing CDN based on reducing the number of hops between the localized CDNs/data centers and the satellite internet constellation birds, again as compared to traversing the ground-based internet.

These and other aspects of the disclosure are described in further detail below.

As noted previously, the popularity and prevalence of CDNs is largely based on the ability of CDNs to provide lower internet latency for their customers' websites. Legacy CDNs can achieve this latency reduction by forward deploying costly hardware into the physical and network locations that are close to the end users of the websites (e.g., the web clients that request content from the websites). These physical and network locations are often the most expensive locations for this CDN hardware to operate in, as the physical space for CDNs is often located in dense urban areas while the network location for CDNs is often provided by an ISP or dedicated internet peering provider.

In one illustrative example, the systems and techniques described herein can be used to more efficiently provide CDN-based latency reduction using satellite internet constellations with ISLs such as optical space lasers. For instance, it can be more cost effective to forward deploy and operate a plurality of satellite internet constellation dishes at locations that are sufficiently close to groups of users that are geographically proximate to one another and a plurality of satellite internet constellation dishes at locations that are sufficiently close to the servers or proxies they are using. As will be described in greater depth below, lower latency (e.g., relative to traversing all the hops of the ground-based internet connection between the users and the servers/proxies) can then be achieved by routing internet traffic through the lower cost user-local satellite internet constellation dishes, up to overhead birds of the constellation, and then across (e.g., via optical space laser or other ISLs) to different birds that are overhead the servers/proxies hosting the requested websites or content (e.g., and/or APIs, internet services, etc.). Accordingly, website operators can increase their capacity at a much lower cost as compared to conventional CDNs, for example by operating (e.g., hosting) their web content in a favored or preferred data center location that connects via a satellite internet constellation link, rather than using expensive, forward-deployed CDN hardware that connects via fiber or other ground-based connection means.

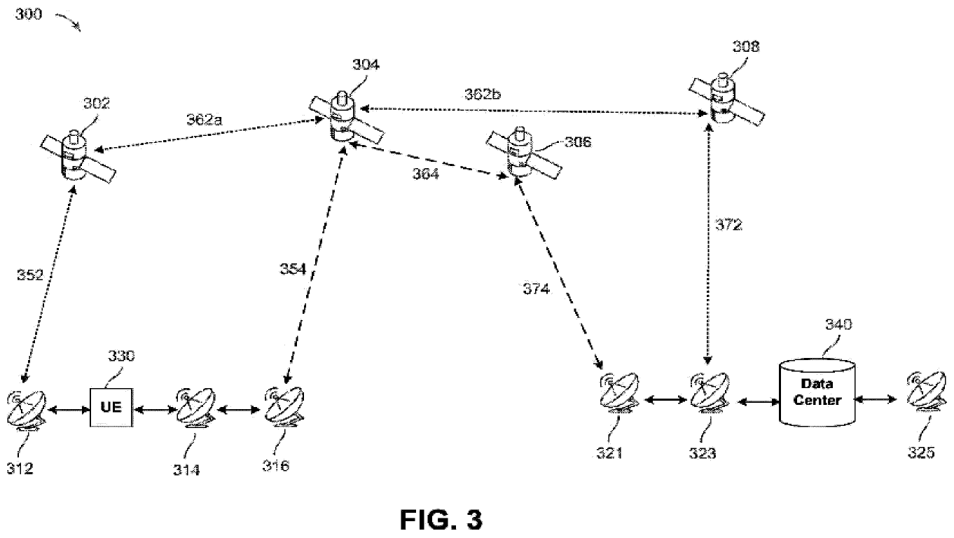

FIG. 3 is a diagram illustrating an example of a satellite internet constellation CDN 300, which in some aspects can be used to provide low latency satellite internet connectivity to a plurality of users. The plurality of users can be associated with a corresponding plurality of UEs, such as the UE 330 depicted in FIG. 3. The UE(s) 330 can include various different computing devices and/or networking devices. In some embodiments, the UEs 330 can include any electronic device capable of connecting to a data network such as the internet.

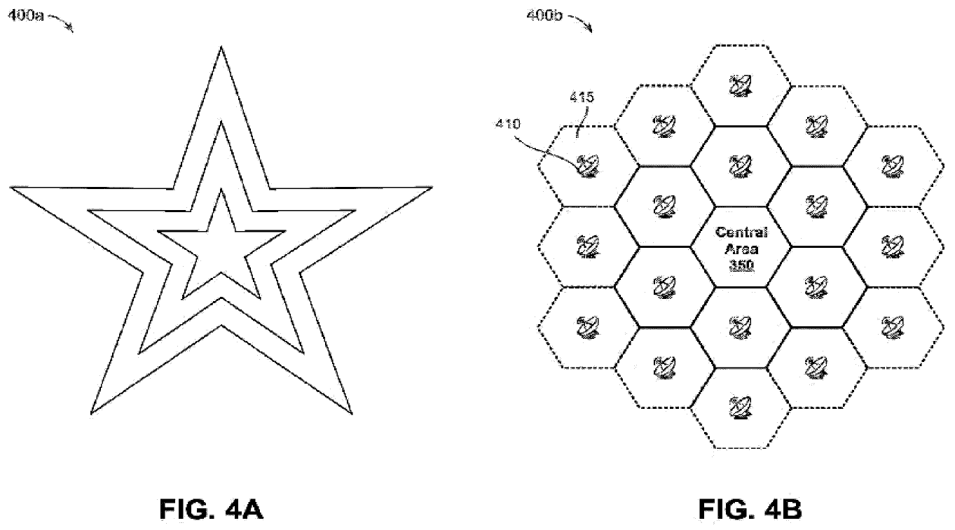

The UE 330 can be associated with a plurality of client-side satellite internet constellation dishes, shown here as the satellite dishes 312, 314, and 316, although it is noted that a greater or lesser quantity of satellite dishes can be used without departing from the scope of the disclosure. In one illustrative example, the UE 330 and the satellite dishes 312, 314, 316 can be associated with one another based on a common or proximate geographic location, area, region, etc. In other words, it is contemplated that a plurality of client-side satellite internet constellation dishes can be deployed to serve (e.g., provide connectivity to the satellite internet constellation) various different geographic areas, with various granularities as desired. For example, a group of satellite dishes can be deployed in and around a city, a town, a region, etc. The groups of satellite dishes can also be deployed in rural areas, i.e., lower-density concentrations of users. In general, it is contemplated that the groups of satellite dishes can be scaled up or down based on factors such as the quantity of users that are to be served, the land area or density of users to be served, the required bandwidth, etc. Additional details of the arrangement of the groups of satellite dishes will be described with respect to FIG. 4.

The client-side satellite dishes 312, 314, 316 can communicate with a satellite internet constellation, shown here as including a first satellite 302, a second satellite 304, a third satellite 306, and a fourth satellite 304. However, it is noted that a greater quantity of satellites can be used to implement the satellite internet constellation, with FIG. 3 presenting a simplified example for purposes of clarity of explanation.

Similarly, a plurality of server-side satellite internet constellation dishes 321, 323, 325 can be provided in association with various different gateways, such as the gateway 340 depicted in FIG. 3. In some embodiments, the gateway 340 can be an internet gateway that provides connectivity to an internet backbone. In some aspects, the gateway 340 can be a data center or CDN that caches, hosts, stores, serves, or otherwise provides web content in response to receiving corresponding client requests for the content. It is again noted that a greater or lesser quantity of server-side satellite dishes can be utilized without departing from the scope of the present disclosure. As was described above with respect to the client-side satellite dishes 312, 314, 316, the server-side satellite dishes 321, 323, 325 can be associated to a respective data center 340 based on a common or proximate geographic location, area, region, etc. In one illustrative example, the server-side satellite dishes 321, 323, 325 can be located at varying levels of proximity to the respective data center 340. For instance, an inner layer of server-side satellite dishes can include the satellite dishes 323 and 325, which may be provided at the closest physical distance to the data center 340. An outer layer of server-side satellite dishes can include at least the satellite dish 321, which is located at a greater distance away from the data center 340 relative to the inner layer dishes 323 and 325. In some embodiments, the outer layer satellite dishes can be communicatively coupled to the inner layer satellite dishes via a wired and/or wireless connection. For example, the outer layer server-side satellite dish 321 can be communicatively coupled to the inner layer server-side satellite dish 323 via a wireless microwave relay connection (among various other wireless/RF connections) and/or can be communicatively coupled to the inner layer server-side satellite dish 323 via a wired fiber connection.

By providing multiple different satellite dishes for communicating with the satellite internet constellation, at both the client-side associated with UE 330 and the server-side associated with datacenter 340, the systems and techniques described herein can increase the satellite constellation ground coverage area available to the UE 330 and to the datacenter 340. For instance, at the client-side associated with UE 330, the number of birds that are visible to or overhead the set of dishes 312, 314, 316 will almost always be greater than the number of birds that are visible to or otherwise overhead any individual one of the three client-side dishes 312, 314, 316. Similarly, at the server-side associated with datacenter 340, the number of birds that are visible to or otherwise overhead the set of the three dishes 321, 323, 325 will almost always be greater than the number of birds that are visible to or otherwise overhead any individual one of the three server-side dishes 321, 323, 325.

The interconnecting of the satellite dishes at each respective client location and at each respective server location, when combined with a satellite internet constellation implement optical space lasers or other ISLs, can enable more direct connectivity between the UE 330 and the datacenter 340. For instance, the UE 330 may use satellite dish 312 to communicate with satellite 302, via a service link 352. As illustrated, satellite 302 is out of range of the data center 340 (e.g., satellite 302 cannot establish a feeder link with any of the server-side dishes 321, 323, 325). In a conventional satellite internet constellation without ISLs, UE 330 would therefore be unable to use satellite 302 to obtain internet connectivity with data center 340 (based on the requirement in conventional satellite internet constellations that the same bird be used to connect the UE and an internet gateway).

Here, however, the UE 330 is able to establish internet connectivity with datacenter 340 via a first ISL 362a between satellite 302 and satellite 304, a second ISL 362b between satellite 304 and satellite 308, and a feeder link from satellite 308 to the server-side satellite dish 323 Notably, the UE 330 can establish internet connectivity with data center 340 via multiple different ISL-based paths through one different sets of birds of the satellite internet constellation. For instance, a first path from UE 330 to datacenter 340 is the combined path 352-362a-362b-372 described above. At least a second path from UE 330 to datacenter 340 may also be utilized. For example, the server-side dish 316 can communicate with satellite 304 via a service link 354, satellite 304 can communicate with satellite 306 via ISL 364, and satellite 306 can communicate with server-side dish 321 via feeder link 374.

Various other paths from the UE 330 to the datacenter 340 can also be utilized, with the two example paths of FIG. 3 provided for purposes of example and illustration, and not intended as limiting. For instance, the UE 330 can establish internet connectivity with datacenter 340 using a combination of: a particular service link selected from a plurality of available service links between one of the client-side dishes 312, 314, 316 to one of the birds of the constellation; one or more particular ISLs selected from a plurality of available ISLs between various combinations of two or more birds of the constellation; and a particular feeder link selected from a plurality of available feeder links between one of the birds of the constellation to one of the server-side dishes 321, 323, 325.

In some embodiments, the plurality of server-side satellite dishes (e.g., the dishes 321, 323, 325) can be located proximate to a datacenter, CDN, or other server-side proxy that serves internet content directly. In this example, the number of hops needed to provide internet connectivity to the UE 330 can be approximately equal to the 2+the number of ISLs in the path through the satellite constellation (e.g., 1x service link from UE 330 to the constellation, 1x feeder link from the constellation to the datacenter 340, and any ISLs taken between the service link satellite and the feeder link satellite).

In another example, the plurality of server-side satellite dishes (e.g., dishes 321, 323, 325) can be located proximate to a terrestrial internet gateway that connects via ground-based connections, such as fiber, to the corresponding datacenter, CDN, server-side proxy, etc., that hosts content requested by UE 330. For instance, one or more server-side satellite dishes can be provided proximate to multiple different terrestrial internet gateways. In this manner, the satellite internet constellation may, in some cases, analyze a client request from UE 330 to determine a particular terrestrial internet gateway that has the lowest latency to a proxy of the web server associated with the client request. Based on the analysis, the satellite internet constellation can determine one or more ISLs to route the client request to a bird that is overhead the identified gateway having the lowest latency to the proxy. In some examples, the satellite internet constellation can determine the lowest latency as the lowest latency from one of the terrestrial internet gateways to a proxy of the requested web server (e.g., without accounting for additional latency introduced by the number of ISLs or inter-satellite constellation hops needed to connect UE 330 to the lowest latency internet gateway). In other example, the satellite internet constellation can determine the lowest latency as being inclusive of both the latency through the ISL hops within the satellite constellation plus the latency through the one or more hops from a gateway to the proxy.

Notably, the systems and techniques described herein can be used to provide lower latency satellite internet by decoupling UE 330 from the limitation of only being able to connect to its local internet gateways. In some cases, the satellite internet constellation can receive signaling from one or more server-side proxies indicative of a current load, predicted load, etc., associated with each respective one of the server-side proxies. Based on the indicated load information for the proxies, the satellite internet constellation can more intelligently route internet traffic to gateways with proxies having sufficient capacity (and/or the most available capacity) to handle the traffic. For instance, the traffic-aware routing (e.g., load balancing) can be implemented in combination with the latency-based routing described above.

In some embodiments, the satellite internet constellation can be configured to inspect and/or analyze the contents of internet traffic from UE 330. For instance, if the satellite internet constellation is able to inspect the contents of client-side internet traffic, a web client (e.g., browser) and/or a satellite internet constellation client-side proxy can maintain a consistent/persistent secure connection with an appropriate gateway proxy, thereby reducing the number of roundtrips by approximately 60%. The roundtrip reduction of 60% may be in addition to the already reduced number of hops between the UE 330 and the datacenter 340.

As noted previously, it is contemplated that the systems and techniques described herein can be implemented across multiple different geographic areas, across various different population densities, across various different bandwidth needs, etc. In one illustrative example, a plurality of satellite dishes can be provided at client-side locations and at server-side locations, with the plurality of satellite dishes configured based at least in part on the density of the service area and the bandwidth requirements of the service area.

For instance, in existing approaches to satellite internet, the satellite internet constellation bandwidth per square meter can be far too small for every user in an urban center (or other high-density area) to be able to install and use their own client-side satellite dish functionally. In one illustrative example, a plurality of client-side satellite dishes (e.g., such as the client-side dishes 312, 314, 316 of FIG. 3) and/or a plurality of server-side satellite dishes (e.g., such as the server-side dishes 321, 323, 325 of FIG. 3) can be utilized to increase the total bandwidth available to a given client-side location or a given server-side location, respectively. For example, a plurality of satellite dishes for communicating with a satellite internet constellation can be provided at the periphery of a relatively high-density location, as land at the periphery is lower cost and lower-density space.

In one illustrative example, one or more layers or rings of satellite dishes can be installed at different distances (e.g., radii) from a central service area (e.g., city, urban area, relatively high-density areas, etc.) that utilizes the satellite dishes for connectivity to the satellite internet constellation. For instance, the one or more layers of satellite dishes can be provided as polygon layers each including a respective plurality of satellite dishes.

FIGS. 4A and 4B depict example satellite dish configurations that can be used to increase an available bandwidth to the satellite internet constellation, at either a client-side location, a server-side location, or both. In particular, the example satellite dish configurations described herein can increase bandwidth based on increasing a total quantity of available between the satellite dishes and the satellite constellation and/or based on increasing a total quantity of birds that are overhead the satellite dish array (e.g., and therefore available for connection).

In one illustrative example, the polygon layers of satellite dishes utilized at the client-side location(s) and/or the server-side location(s) can be implemented as star-shaped layers of satellite dishes, as depicted in the example of FIG. 4A. In this example, a satellite dish can be installed at some (or all) of the vertices of each star-shaped layer. For instance, FIG. 4A depicts an inner layer, a middle layer, and an outer layer of satellite dishes, although it is noted that a greater or lesser quantity of layers can also be utilized. In one example, a satellite dish can be provided at each vertex of each layer, in which case each respective star-shaped layer includes 10 satellite dishes. Various other arrangements are also possible for the constituent satellite dishes included in each respective layer. For instance, a satellite dish can be provided at each of the five outer vertices of each layer, but not at the five inner vertices; a satellite dish can be provided at each of the five inner vertices of each layer, but not at the five outer vertices; successive layers can alternate between providing satellite dishes at only the inner vertices and only the outer vertices; etc.

The polygon layers of satellite dishes can be centered around a central service area that will consume or utilize the satellite internet constellation connectivity and bandwidth provided by the polygon layers of satellite dishes. The central service area can be a client-side service area, can be a server-side service area, or various combinations of the two (e.g., the plurality of dishes included in the polygon layers can be used to provide service links between the constellation and UEs within the central service area, can be used to provide feeder links between the constellation and gateways/datacenters/CDNs within the central service area, or both).

In some embodiments, the quantity of satellite dishes provided in each polygon layer can be determined such that the plurality of satellite dishes across the total set of polygon layers saturates the maximum quantity of satellite constellation birds that may be overhead at any given time. In other words, the polygon layers can be arranged and populated with a quantity of satellite dishes that corresponds to the satellite internet constellation maximum density. Accordingly, the plurality of polygon layers of satellite dishes can be used to allow increasing numbers of users in high density locations to reach the satellite internet constellation, and therefore internet gateways (and/or CDNs, datacenters, proxies, etc.) that are distant from the high density user service area but are also connected to the satellite internet constellations (e.g., as described with respect to FIG. 3 above).

In one illustrative example, an innermost polygon layer of satellite dishes (e.g., the innermost star-shaped layer depicted in FIG. 4A) can be utilized to provide direct connectivity with various users and UEs that are located within the central service area of the multiple polygon layers. For example, the innermost layer of satellite dishes can communicate with the various users and UEs via wired and/or wireless connections.

Some, or all, of the outer polygon layers (e.g., all but the innermost layer) can be connected to the inner polygon layer. For example, the outer polygon layers can ground-connect to the inner polygon layer via fiber or other wired connection(s) and/or can connect to the inner polygon layer via point-to-point ground-based wireless connectivity, such as microwave or other RF relay technologies. In some embodiments, each satellite dish provided in a given outer polygon layer can be communicatively connected to at least one satellite dish of the inner polygon layer. For example, each satellite dish in each respective outer layer can be connected to the closest satellite dish of the inner layer.

In some examples, each outer layer of satellite dishes can be directly connected to at least one inner layer satellite dish. In another example, each layer of satellite dishes can be directly connected to at least one dish in the immediately adjacent layer. For instance, in the context of FIG. 4A, dishes located in the outermost star-shaped layer can connect to at least one dish in the middle star-shaped layer (e.g., can connect to the closest dish in the middle layer). Similarly, each dish located in the middle of the three star-shaped layers can connect to at least one dish in the inner star-shaped layer. In this case, the connections between the middle layer dishes and the inner layer dishes are responsible for forwarding traffic from both the middle layer and the outer layer to the inner layer dishes.

In some aspects, some (or all) of the respective satellite dishes included in a given polygon layer can be interconnected with one another (e.g., some or all of the plurality of dishes of the inner star-shaped layer can be interconnected with one another; some or all of the plurality of dishes of the outer star-shaped layer can be interconnected with one another; etc.). In this example, one or more of the outer layer dishes can indirectly connect to an inner layer dish via the interconnections within each of the outer layers. For example, a subset of outer layer dishes can be configured to aggregate traffic from other outer layer dishes (via the inter-layer connections between dishes) and then forward the outer layer traffic to the inner layer.

It is noted the various connectivity options described above can be bidirectional, such that traffic can flow from the outer layer dishes to the inner layer dishes (and then on to the client-side and/or server-side devices located within the coverage area of the plurality of polygon layers of satellite dishes), and can also flow from the inner layer dishes to the outer layer dishes.

FIG. 4B depicts another example configuration of a plurality of satellite dishes that can be arranged in rings or layers about a central service area 350. In this example, a plurality of satellite dishes 410 are shown, along with a corresponding coverage area 415 that may be associated with each of the satellite dishes 410. The coverage areas 415 are depicted as hexagonal in shape, although it is noted that this is for purposes of illustration, and various other coverage area sizes, shapes, geometries, etc., may also be utilized.

The plurality of satellite dishes 410 can be arranged about the central service area 450 such that the corresponding plurality of coverage areas 415 provide continuous coverage within the region enclosed by or otherwise associated with the plurality of satellite dishes 410. For instance, the hexagonal coverage areas 415 tessellate, and therefore can be used to provide continuous and/or overlapping coverage at any given location within the layers of satellite dishes. Here, a first layer or ring of satellite dishes can include the six satellite dishes 410 with corresponding coverage areas 415 that are immediately adjacent to the central service area 350 (e.g., the six satellite dishes that share an edge with the central service area 350). An outer layer or ring of satellite dishes can include the 12 satellite dishes 410 with corresponding coverage areas 415 that are immediately adjacent (e.g., share an edge with) one of the six inner layer satellite dishes. A greater or less quantity of satellite dish layers than the two layers depicted in FIG. 4B can be utilized without departing from the scope of the present disclosure. Connections can be provided between pairs of dishes that are located in different layers and/or connections can be provided between pairs of dishes that are located in the same layer (e.g., in a manner the same as or similar to that described above with respect to FIG. 4A).

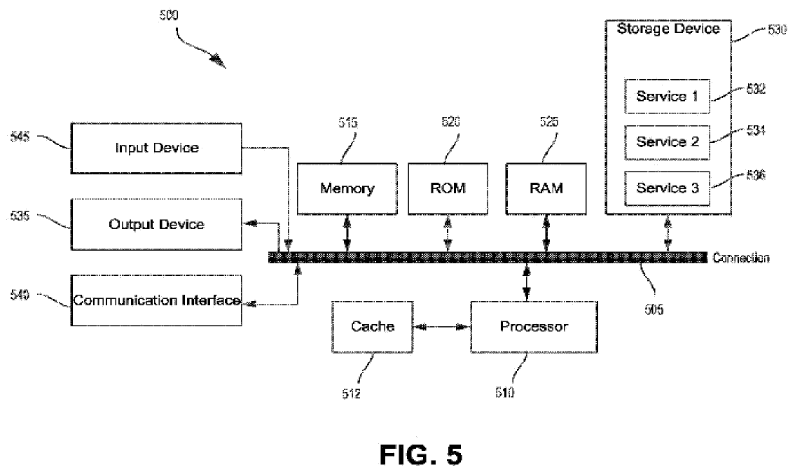

In some examples, the systems and techniques described herein can be implemented or otherwise performed by a computing device, apparatus, or system. In one example, the systems and techniques described herein can be implemented or performed by a computing device or system having the computing device architecture 500 of FIG. 5. The computing device, apparatus, or system can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a laptop computer, a smart television, a camera, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Processes described herein can comprise a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 illustrates an example computing device architecture 500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 500 are shown in electrical communication with each other using connection 505, such as a bus. The example computing device architecture 500 includes a processing unit (CPU or processor) 510 and computing device connection 505 that couples various computing device components including computing device memory 515, such as read only memory (ROM) 520 and random-access memory (RAM) 525, to processor 510.

Computing device architecture 500 can include a cache of high-speed memory connected directly with, in close proximity to, or integrated as part of processor 510. Computing device architecture 500 can copy data from memory 515 and/or the storage device 530 to cache 512 for quick access by processor 510. In this way, the cache can provide a performance boost that avoids processor 510 delays while waiting for data. These and other engines can control or be configured to control processor 510 to perform various actions. Other computing device memory 515 may be available for use as well. Memory 515 can include multiple different types of memory with different performance characteristics. Processor 510 can include any general-purpose processor and a hardware or software service, such as service 1 532, service 2 534, and service 3 536 stored in storage device 530, configured to control processor 510 as well as a special-purpose processor where software instructions are incorporated into the processor design. Processor 510 may be a self-contained system, containing multiple cores or processors, a bus, memory controller, cache, etc. A multi-core processor may be symmetric or asymmetric.

To enable user interaction with the computing device architecture 500, input device 545 can represent any number of input mechanisms, such as a microphone for speech, a touch-sensitive screen for gesture or graphical input, keyboard, mouse, motion input, speech and so forth. Output device 535 can also be one or more of a number of output mechanisms known to those of skill in the art, such as a display, projector, television, speaker device, etc. In some instances, multimodal computing devices can enable a user to provide multiple types of input to communicate with computing device architecture 500. Communication interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof. Storage device 530 can include services 532, 534, 536 for controlling processor 510. Other hardware or software modules or engines are contemplated. Storage device 530 can be connected to the computing device connection 505. In one aspect, a hardware module that performs a particular function can include the software component stored in a computer-readable medium in connection with the necessary hardware components, such as processor 510, connection 505, output device 535, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A system for wireless communications, the system comprising: a plurality of satellite dishes provided about a first location and configured for communication with a satellite internet constellation, wherein each respective satellite dish is communicatively interconnected with one or more satellite dishes of the plurality of satellite dishes; and a user equipment (UE) communicatively coupled to an adjacent satellite dish of the plurality of satellite dishes, wherein: data traffic of the UE is routed from the adjacent satellite dish to a selected satellite dish of the plurality of satellite dishes; the data traffic of the UE is transmitted to the satellite internet constellation using the selected satellite dish; and the data traffic of the UE is routed to an internet gateway using one or more inter-satellite links (ISLs) between respective pairs of satellites of the satellite internet constellation.

Aspect 2. The system of Aspect 1, wherein the adjacent satellite dish transmits the data traffic of the UE to the selected satellite dish using one or more hops between intermediate satellite dishes of the plurality of satellite dishes.

Aspect 3. The system of Aspect 2, wherein the intermediate satellite dishes are selected from a group of interconnected satellite dishes provided between the adjacent satellite dish and the selected satellite dish.

Aspect 4. The system of Aspect 1, wherein: a location of the adjacent satellite dish is different from a location of the selected satellite dish; and a subset of satellites of the satellite internet constellation available to the adjacent satellite dish is different from a subset of satellites of the satellite internet constellation available to the selected satellite dish.

Aspect 5. The system of Aspect 4, wherein the selected satellite dish transmits the data traffic of the UE to a particular satellite of the satellite internet constellation, and wherein the particular satellite is beyond a communication range of the adjacent satellite dish.

Aspect 6. The system of Aspect 1, wherein: the plurality of satellite dishes are arranged in two or more concentric layers disposed beyond a perimeter of the first location, each layer including a subset of the plurality of satellite dishes.

Aspect 7. The system of Aspect 6, wherein: the adjacent satellite dish is included in an inner layer of the two or more concentric layers; and the selected satellite dish is included in a layer different from the inner layer.

Aspect 8. The system of Aspect 6, wherein: the two or more concentric layers include at least an inner layer and an outer layer; and at least one satellite dish included in the inner layer is communicatively coupled to at least one satellite dish included in the outer layer.

Aspect 9. The system of Aspect 1, wherein the selected satellite dish is selected based on a latency or round trip time (RTT) associated with an available path between the selected satellite dish and the internet gateway.

Aspect 10. The system of Aspect 1, wherein the selected satellite dish is selected based on having a lowest latency to the internet gateway.

Aspect 11. The system of Aspect 1, wherein: the internet gateway is selected from a plurality of internet gateways associated with the satellite internet constellation, based on the internet gateway having a lowest latency or closest proximity to a content server associated with the data traffic of the UE.

Aspect 12. The system of Aspect 1, wherein the internet gateway comprises a server-side proxy or a datacenter of a Content Delivery Network (CDN).

Aspect 13. The system of Aspect 12, wherein: the selected satellite dish is selected based on identifying a routing path from the selected satellite dish to a satellite of the satellite internet constellation having a lowest latency or round trip time (RTT) to the server-side proxy or datacenter of the CDN.

Aspect 14. The system of Aspect 1, wherein: the data traffic of the UE is transmitted by the selected satellite dish to an ingress satellite of the satellite internet constellation; and the data traffic of the UE is transmitted from an egress satellite of the satellite internet constellation to the internet gateway.

Aspect 15. The system of Aspect 14, wherein the one or more ISL links are provided between the ingress satellite and the egress satellite.

Aspect 16. The system of Aspect 14, wherein the selected satellite dish is selected based at least in part on a communication link being available between the selected satellite dish and the ingress satellite, and wherein a communication link between the adjacent satellite dish and the ingress satellite is unavailable.

Aspect 17. The system of Aspect 1, further comprising: a second plurality of satellite dishes provided about a second location and configured for communication with the satellite internet constellation, wherein each respective satellite dish is communicatively interconnected with one or more satellite dishes of the second plurality of satellite dishes.

Aspect 18. The system of Aspect 17, wherein: the second location is a location of a server-side proxy or a datacenter of a Content Delivery Network (CDN); and data traffic addressed to the UE is routed through the second plurality of satellite dishes to a second selected satellite dish configured to transmit, to the satellite internet constellation, the data traffic addressed to the UE.

Aspect 19. The system of Aspect 18, wherein the data traffic addressed to the UE is further routed from an ingress satellite of the satellite internet constellation to an egress satellite of the satellite internet constellation, using one more ISLs between a corresponding one or more pairs of satellites of the satellite internet constellation.

Aspect 20. The system of Aspect 19, wherein: the egress satellite transmits the data traffic addressed to the UE to the selected satellite dish of the plurality of satellite dishes; and the data traffic addressed to the UE is forwarded from the selected satellite dish to the UE via one or more intermediate satellite dishes.

Aspect 21. An apparatus comprising means for performing any of the operations of Aspects 1 to 20.

Aspect 22. A non-transitory computer-readable storage medium having stored thereon instructions which, when executed by one or more processors, cause the one or more processors to perform any of the operations of Aspects 1 to 20.

Aspect 23. A method comprising any of the operations of Aspects 1 to 20.

What is claimed is:

1. A system for wireless communications, the system comprising:
a plurality of satellite dishes provided about a first location and configured for communication with a satellite internet constellation, wherein each respective satellite dish is communicatively interconnected with one or more satellite dishes of the plurality of satellite dishes; and
a user equipment (UE) communicatively coupled to an adjacent satellite dish of the plurality of satellite dishes, wherein:
data traffic of the UE is routed from the adjacent satellite dish to a selected satellite dish of the plurality of satellite dishes;
the data traffic of the UE is transmitted to the satellite internet constellation using the selected satellite dish; and
the data traffic of the UE is routed to an internet gateway using one or more inter-satellite links (ISLs) between respective pairs of satellites of the satellite internet constellation.

2. The system of claim 1, wherein the adjacent satellite dish transmits the data traffic of the UE to the selected satellite dish using one or more hops between intermediate satellite dishes of the plurality of satellite dishes.

3. The system of claim 2, wherein the intermediate satellite dishes are selected from a group of interconnected satellite dishes provided between the adjacent satellite dish and the selected satellite dish.

4. The system of claim 1, wherein:
a location of the adjacent satellite dish is different from a location of the selected satellite dish; and
a subset of satellites of the satellite internet constellation available to the adjacent satellite dish is different from a subset of satellites of the satellite internet constellation available to the selected satellite dish.

5. The system of claim 4, wherein the selected satellite dish transmits the data traffic of the UE to a particular satellite of the satellite internet constellation, and wherein the particular satellite is beyond a communication range of the adjacent satellite dish.

6. The system of claim 1, wherein:
the plurality of satellite dishes are arranged in two or more concentric layers disposed beyond a perimeter of the first location, each layer including a subset of the plurality of satellite dishes.

7. The system of claim 6, wherein:
the adjacent satellite dish is included in an inner layer of the two or more concentric layers; and
the selected satellite dish is included in a layer different from the inner layer.

8. The system of claim 6, wherein:
the two or more concentric layers include at least an inner layer and an outer layer; and
at least one satellite dish included in the inner layer is communicatively coupled to at least one satellite dish included in the outer layer.

9. The system of claim 1, wherein the selected satellite dish is selected based on a latency or round trip time (RTT) associated with an available path between the selected satellite dish and the internet gateway.

10. The system of claim 1, wherein the selected satellite dish is selected based on having a lowest latency to the internet gateway.

11. The system of claim 1, wherein:
the internet gateway is selected from a plurality of internet gateways associated with the satellite internet constellation, based on the internet gateway having a lowest latency or closest proximity to a content server associated with the data traffic of the UE.

12. The system of claim 1, wherein the internet gateway comprises a server-side proxy or a datacenter of a Content Delivery Network (CDN).

13. The system of claim 12, wherein:
the selected satellite dish is selected based on identifying a routing path from the selected satellite dish to a satellite of the satellite internet constellation having a lowest latency or round trip time (RTT) to the server-side proxy or datacenter of the CDN.

14. The system of claim 1, wherein:
the data traffic of the UE is transmitted by the selected satellite dish to an ingress satellite of the satellite internet constellation; and
the data traffic of the UE is transmitted from an egress satellite of the satellite internet constellation to the internet gateway.

15. The system of claim 14, wherein the one or more ISL links are provided between the ingress satellite and the egress satellite.

16. The system of claim 14, wherein the selected satellite dish is selected based at least in part on a communication link being available between the selected satellite dish and the ingress satellite, and wherein a communication link between the adjacent satellite dish and the ingress satellite is unavailable.

17. The system of claim 1, further comprising:
a second plurality of satellite dishes provided about a second location and configured for communication with the satellite internet constellation, wherein each respective satellite dish is communicatively interconnected with one or more satellite dishes of the second plurality of satellite dishes.

18. The system of claim 17, wherein:
the second location is a location of a server-side proxy or a datacenter of a Content Delivery Network (CDN); and
data traffic addressed to the UE is routed through the second plurality of satellite dishes to a second selected satellite dish configured to transmit, to the satellite internet constellation, the data traffic addressed to the UE.

19. The system of claim 18, wherein the data traffic addressed to the UE is further routed from an ingress satellite of the satellite internet constellation to an egress satellite of the satellite internet constellation, using one more ISLs between a corresponding one or more pairs of satellites of the satellite internet constellation.

20. The system of claim 19, wherein:
the egress satellite transmits the data traffic addressed to the UE to the selected satellite dish of the plurality of satellite dishes; and
the data traffic addressed to the UE is forwarded from the selected satellite dish to the UE via one or more intermediate satellite dishes.
